(19) United States
(12) Patent Application Publication
(10) Pub. No.: US 2010/0056078 A1
(43) Pub. Date: Mar. 4, 2010

(54) SYSTEM AND METHOD FOR PROVIDING EXTERNAL POWER TO A DEVICE THAT PROVIDES CONNECTIVITY TO A WIRELESS RADIO FREQUENCY ACCESS NETWORK

(76) Inventors: Lowell Phillip Feldman, Austin, TX (US); Soren Williams Telfer, Ann Arbor, MI (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/199,394

(22) Filed: Aug. 27, 2008

(51) Int. Cl. H04B 1/40; H01Q 1/00

(52) U.S. Cl. 455/90.3; 343/721

(57) ABSTRACT

The device disclosed herein may be used to provide external power and connectivity to a wireless radio frequency access network. In particular, the device may include a “light bulb” screw-type plug, which may be screwed into a standard alternating current light socket. The device draws an alternating current voltage from the light socket and converts the alternating current voltage into a direct current voltage. The direct current voltage may then power various components of the device, which provide connectivity to a wireless radio frequency access network. As such, external power may be provided to the device through the light socket, whereby the device can operate as a wireless radio frequency access point without wires or cables running thereto.

### FIELD OF THE INVENTION

The invention relates to providing external power to a device, which provides connectivity to a wireless radio frequency access network, without having to run wires or cables to the device.

### BACKGROUND OF THE INVENTION

Wireless networks have gained increased prominence in recent years because of their ability to provide flexibility and mobility to network nodes. Wireless networks typically operate using radio frequency (RF) energy to link computers in a particular network area, thus providing wireless network nodes with connectivity to a local area radio frequency access network. Furthermore, in some cases, wireless networks may be designed to cover broader network areas, including wide area radio frequency access networks that link various local area radio frequency access networks to one another. Typically, wireless networks provide connectivity to an access network through one or more access points that emit radio frequency energy (e.g., through a small antenna). Wireless nodes within range of one or more of the wireless access points may receive the radio frequency energy and then communicate with the wireless access point to access the supported wireless network.

Although wireless networks can operate using very low amounts of power (e.g., typically one watt or less), finding external power sources for wireless access points is a common problem in many wireless network installations. For example, to make a wireless network access point accessible to outdoor nodes or other wireless interfaces, wires or cables must typically be run to the location of a suitable power source. However, even when a suitable power source is available, the power source may be situated in a less than optimal location for the access point. Thus, finding a suitable external power source for a wireless radio frequency access network can often present significant and important challenges.

Existing techniques for providing power and connectivity for a wireless radio frequency access network have tended to focus on sneaking wires or cables to a suitable power source. However, running wires and cables can be a costly and difficult initiative, potentially introducing various logistical hurdles to a wireless network installation. Furthermore, the need to run wires or cables may mitigate many of the advantages and flexibility of a wireless network infrastructure. To address these concerns, another technique that has been used to power wireless network access points employs otherwise unused wire pairs on Ethernet cables to carry the electrical current needed to operate a network device. Despite eliminating one set of wiring hassles (i.e., running wires to carry external power), wireless network installations using the Power-over-Ethernet (PoE) technique must still address the logistical challenges involved with running Ethernet or other network cables to the wireless radio frequency access points.

Existing techniques for providing external power and connectivity to wireless radio frequency network access points suffer from these and other problems.

### SUMMARY OF THE INVENTION

According to various aspects of the invention, external power may be provided to a device that provides connectivity to a wireless radio frequency (RF) access network in a manner that addresses these and other problems with existing techniques. In particular, the device may include a fitting that can be screwed into a standard alternating current (AC) light socket. The device may receive an alternating current voltage (VAC) from the light socket and convert the alternating current voltage into a direct current voltage (VDC). The direct current voltage may then power various components of the device to provide connectivity to a wireless radio frequency access network. As such, external power may be provided to the device to be described in further detail herein through the light socket, whereby the device can operate as a wireless radio frequency network access point without wires or cables running to the device.

According to one aspect of the invention, a compact electronic device may include a “light bulb” screw-type plug, which may be compatible with standard light sockets. In one implementation, the screw-type plug may include a metal fitting having a plurality of screw threads compatible with any suitable standard screw-in AC light socket. The screw-type plug may include one or more electrical contacts, which may draw an alternating current voltage from electrical contacts in the light socket. The device may further include an AC to DC power supply that converts AC voltage into DC voltage, and a DC power supply may use the DC voltage to power a circuit board housed within an environmentally hardened enclosure. The circuit board may include, among other things, a System-on-Chip (e.g., an embedded system that integrates various components and functions of the device). The circuit board may further include a local area RF module and a wide area RF module, each of which may operate at various combinations of frequencies and data link layer protocols (e.g., IEEE 802.11a/b/g, WiMAX, 3GPP Long Term Evolution, a proprietary standard, etc.). The local area RF module may be communicatively coupled to a local area RF antenna, and the wide area RF module may be communicatively coupled to a wide area RF antenna. As such, the device may use the power received through the light socket to provide a local area RF access network via the local area RF antenna. Furthermore, the device may link the local area RF access network to a wide area RF access network via the wide area RF antenna.

Other objects and advantages of the invention will be apparent to those skilled in the art based on the following drawings and detailed description.

### BRIEF DESCRIPTION OF THE DRAWINGS

FIG. 1 illustrates an exemplary device for providing external power and connectivity to a wireless radio frequency access network, according to one aspect of the invention.

FIGS. 2a-b respectively illustrate a block diagram and a schematic diagram of an exemplary device for providing external power and connectivity to a wireless radio frequency access network, according to one aspect of the invention.

### DETAILED DESCRIPTION

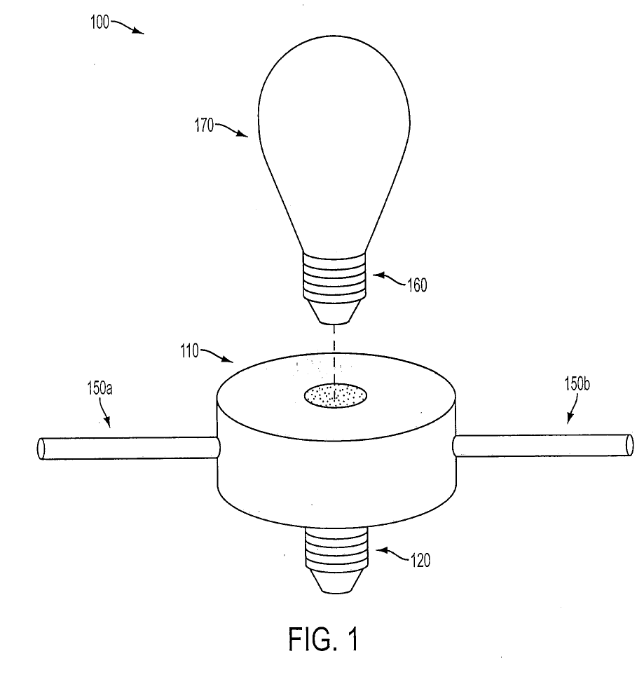

According to one aspect of the invention, FIG. 1 illustrates an exemplary compact electronic device 100 for providing external power and connectivity to a wireless radio frequency (RF) access network. The electronic device 100 may include a “light bulb” screw-type plug 120, which may include a fitting compatible with any standard screw-in light socket. For example, in various implementations, the screw-type plug 120 may be compatible with light sockets of varying standard diameters, including E12 candelabra sockets, E17 intermediate sockets, E26 standard sockets, E39 mogul sockets, or any other commonly used screw-in light socket. As such, the screw-type plug 120 may provide a mechanism that enables the electronic device 100 to be screwed into a standard screw-type light socket.

In one implementation, the screw-type plug 120 may include a metal fitting having one or more electrical contacts that draw an alternating current voltage (VAC) from electrical contacts in the light socket. The alternating current voltage passes through the screw-type plug 120 and into an alternating current (AC) to direct current (DC) power supply via the electrical contacts.

In one implementation, an environmentally hardened enclosure 110 may protect certain components of the electronic device 100 from being exposed to environmental elements. As such, in one implementation, the AC to DC power supply may be housed within the environmentally hardened enclosure 110 (e.g., to protect against short-circuits or other electrical failures). Alternatively, in one implementation, the AC to DC power supply may be housed within a separate enclosure that resides outside of the environmentally hardened enclosure 110.

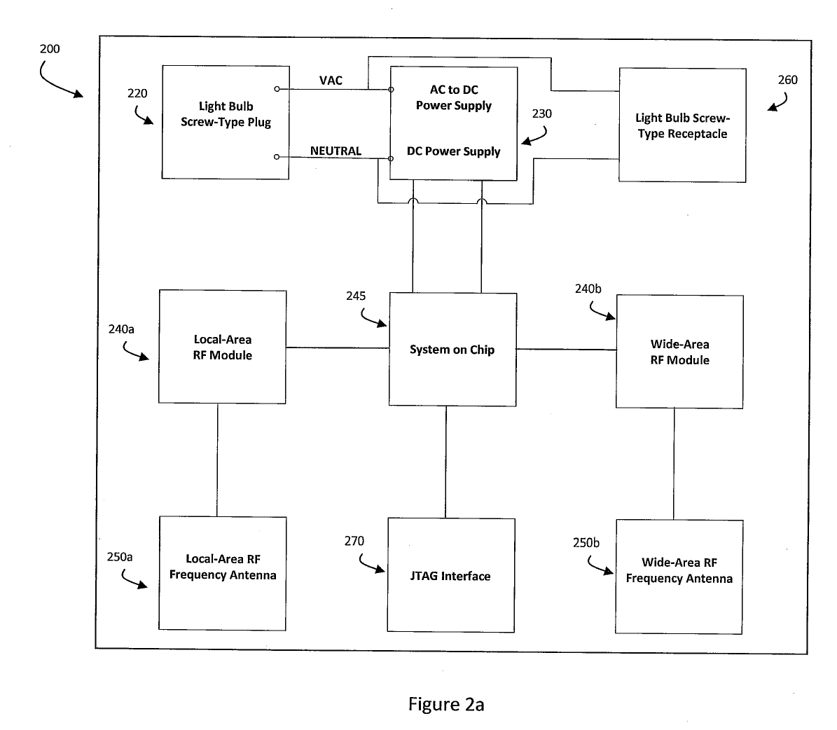

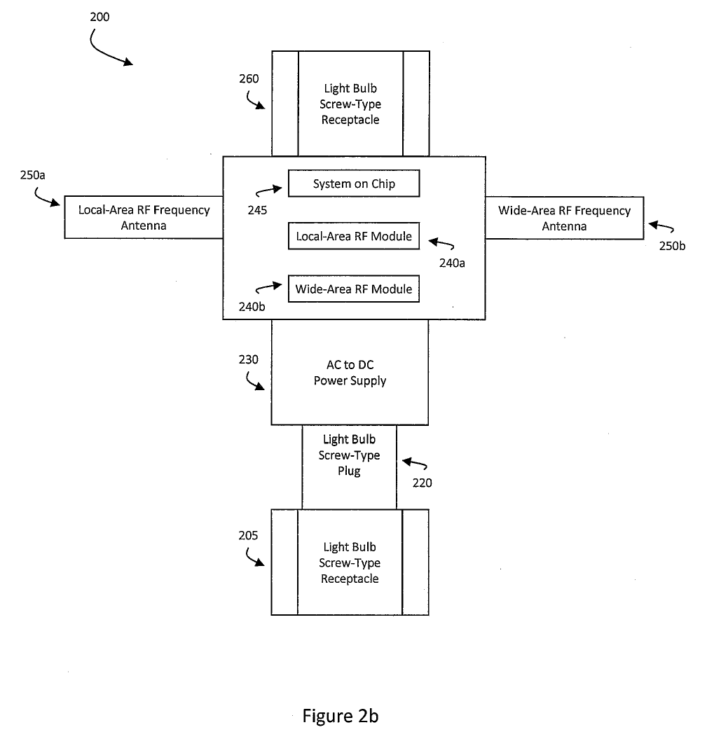

The AC to DC power supply may convert the alternating current voltage (VAC) into direct current voltage (VDC). The AC to DC power supply further includes a DC power supply, which uses the direct current voltage to power a circuit board, which includes various components that provide connectivity to a wireless RF access network (as will be described in greater detail below in reference to FIGS. 2a-b). In one implementation, the circuit board may be housed within the environmentally hardened enclosure 110 to protect the circuitry from being exposed to environmental conditions.

The circuit board may be communicatively coupled to a local area RF antenna 150a and a wide area RF antenna 150b, each of which may be exposed outside of the enclosure 110, at least in part. As such, the electronic device 100 may use the power received from the light socket to communicate wirelessly using RF energy via the local area RF antenna 150a and the wide area RF antenna 150b. For example, the electronic device 100 may provide connectivity to a local area RF access network via the local area RF antenna 150a. Furthermore, the electronic device 100 may link the local area RF access network to a wide area RF access network via the wide area RF antenna 150b.

The electronic device 100 may further include a standard screw-type receptacle 160 that accepts a standard screw-type light bulb 170. In one implementation, the screw-type receptacle 160 may be wired in parallel to the screw-type light socket, and may provide a screw-type light socket substantially similar to the screw-type light socket. Additionally, as discussed above, each of the screw-type receptacle 160 and the screw-type light socket may be compatible with any of the varying standard diameters for light sockets.

In one implementation, the electronic device 100 may detect the presence of a light bulb 170 that has been placed into the screw-type receptacle 160. Moreover, the device 100 may determine a proper or improper operational status of the light bulb 170 placed in the screw-type receptacle 160. The operational status may then be relayed over the local area RF access network via the local area RF antenna 150a, or over the wide area RF access network via the wide area RF antenna 150b. As such, one or more nodes on the local area RF access network or the wide area RF access network may receive information relating to the operational status of the light bulb 170, wherein such information may be used for troubleshooting the electronic device 100, among other things.

According to one aspect of the invention, FIG. 2a illustrates a block diagram of a compact electronic device 200 that can provide external power and connectivity to a wireless RF access network. In addition, according to one aspect of the invention, FIG. 2b illustrates a schematic diagram corresponding to the electronic device 200 to be described in further detail herein. As such, the following description of the electronic device 200 may be treated as referring to either or both of FIGS. 2a-b, whether or not explicitly described.

As previously discussed, the electronic device 200 may include a light bulb screw-type plug 220, which may include a metal fitting compatible with a standard screw-in light socket. The light bulb screw-type plug 220 may be compatible with light sockets of varying standard diameters, including E12 candelabra sockets, E17 intermediate sockets, E26 standard sockets, E39 mogul sockets, or any other commonly used screw-in light socket. As such, the light bulb screw-type plug 220 may be used to screw the electronic device 200 into a standard socket.

The light bulb screw-type plug 220 may include one or more electrical contacts that draw an alternating current voltage from electrical contacts in a light socket. The alternating current voltage and a neutral voltage may collectively pass through the light bulb screw-type plug 220 into an AC to DC power supply 230. The AC to DC power supply 230 then converts the alternating current voltage into a direct current voltage. The power supply 230 uses the direct current voltage (via a DC power supply) to power a circuit board that includes various components capable of providing connectivity to one or more wireless RF access networks.

The circuit board may include, among other things, a System-on-Chip (SoC) 245 (e.g., an integrated circuit or a special-purpose embedded system that integrates various components and functions). The circuit board may further include a local area RF module 240a and a wide area RF module 240b. Each of the local area RF module 240a and the wide area RF module 240b may operate at any suitable combination of frequencies and data link layer protocols (e.g., IEEE 802.11a/b/g, WiMAX, 3GPP Long Term Evolution, a proprietary standard, etc.). In particular, local area RF module 240a may be coupled to a local area RF antenna 250a, and the wide area RF module 240b may be coupled to a wide area RF antenna 250b. The electronic device 200 can then use the power received through the light bulb screw-type plug 220 to communicate using RF energy via the local and wide area RF antennas 150a-b.

For example, in one implementation, the wide area RF module 240b may communicate via the wide area RF antenna 250b using the IEEE 802.16 standard in order to link to a WiMAX network, which may employ one or more frequencies in the RF spectrum capable of providing wireless data over long distances or over a large coverage area. In one implementation, the local area RF module 240a may communicate via the local area RF antenna 150a using an IEEE 802.11 standard. In such an implementation, the local area RF antenna 150a may operate at a frequency within the RF spectrum that provides wireless data for local area RF networks (which generally cover a smaller area or region than a wide area RF access network).

As a result, the electronic device 200 may provide connectivity to a local area RF access network via the local area RF antenna 250a, and the electronic device 200 may link the local area RF access network to a wide area RF access network via the wide area RF antenna 250b. It will be further apparent that the local area RF antenna 250a and/or the wide area RF antenna 250b may operate using any suitable combination of network protocols and/or frequencies to provide and/or link the local area RF access network and the wide area RF access network. For example, in one implementation, the electronic device 200 may include any suitable combination of hardware, software, and/or firmware that can enable a user to specify the operable network protocols and/or frequencies (e.g., an external switch or a web-based interface may provide the user with a mechanism for communicating with internal circuitry of the device 200).

The electronic device 200 may further include a standard light bulb screw-type receptacle 260 that accepts a standard screw-type light bulb. In one implementation, the screw-type receptacle 260 may be wired in parallel to the light bulb screw-type plug 220, and may provide a screw-type light socket substantially similar to that of the light bulb screw-type plug 220. Additionally, it will be apparent that the screw-type receptacle 260 and the light bulb screw-type plug 220 may both be compatible with any standard diameter light socket.

In one implementation, the electronic device 200 may detect the presence of a light bulb that has been placed into the screw-type receptacle 260. Moreover, the device 200 may determine a proper or improper operational status of the light bulb 270 placed in the screw-type receptacle 260, and the operational status may then be relayed over the local area RF access network via the local area RF antenna 250a, or over the wide area RF access network via the wide area RF antenna 250b. As such, one or more nodes on the local area RF access network or the wide area RF access network may receive information relating to the operational status of the light bulb 270, wherein such information may be used for troubleshooting the electronic device 200, among other things.

In one implementation, the electronic device 200 may further include a Joint Test Action Group (JTAG) interface 270 based on the IEEE 1149.1 standard. In one implementation, the JTAG interface 270 may be used to perform a boundary scan that can test one or more of the circuit board, the SoC 245, or any other integrated circuit or sub-block of an integrated circuit associated with the device 200. As such, the JTAG interface 270 may provide a low bit rate interface that can be used for debugging various combinations of one or more components of the electronic device 200. For example, the JTAG interface 270 may provide a transport mechanism for accessing information relating to various components of the device 200. In particular, to troubleshoot the device 200, a test probe may be connected to a port on the JTAG interface 270 in order to access information relating to any given component on the circuit board. As such, the JTAG interface 270 may be used to test the circuit board or various combinations of the components of the device 200 (e.g., for faults such as a short circuit, an open circuit, a logic error, etc.).

Aspects and implementations may be described as including a particular feature, structure, or characteristic, but every aspect or implementation may not necessarily include the particular feature, structure, or characteristic. Further, when a particular feature, structure, or characteristic has been described in connection with an aspect or implementation, it will be understood that such feature, structure, or characteristic may be included in connection with other aspects or implementations, whether or not explicitly described. Thus, various changes and modifications may be made to the preceding description without departing from the scope or spirit of the invention, and the specification and drawings should therefore be regarded as exemplary only, and the scope of the invention determined solely by the appended claims.

What is claimed is:

1. An externally powered electronic device that provides connectivity to a wireless radio frequency access network, comprising:
a screw-type plug that can be screwed into a standard alternating current light socket, wherein the screw-type plug has at least one electrical contact that draws an alternating current voltage from the light socket;
a power supply electrically coupled to the screw-type plug, wherein the power supply converts the alternating current voltage drawn from the light socket into a direct current voltage that powers a circuit board; and
at least one radio frequency antenna, wherein the powered circuit board causes the radio frequency antenna to transmit and receive information using a predetermined frequency and a predetermined network protocol, thereby providing connectivity to a wireless radio frequency access network.

2. The electronic device of claim 1, wherein the electrical contact draws the alternating current voltage from the light socket when the metal fitting has been screwed into the light socket.

3. The electronic device of claim 2, wherein the power supply comprises an alternating current to direct current power supply that converts the alternating current voltage into the direct current voltage.

4. The electronic device of claim 1, wherein the predetermined network protocol comprises a data link layer network protocol.

5. The electronic device of claim 4, wherein the predetermined network protocol includes at least one of an IEEE 802.11 protocol, an IEEE 802.16 network protocol, or a 3GPP Long Term Evolution network protocol.

6. The electronic device of claim 4, further comprising a System-on-Chip (SoC) and a local area radio frequency module coupled to the circuit board, wherein the SoC and the local area radio frequency module collectively cause the radio frequency antenna to transmit and receive information using the predetermined frequency and the predetermined network protocol, whereby the wireless radio frequency access network comprises a wireless local area network.

7. The electronic device of claim 1, further comprising an environmentally hardened enclosure that houses the circuit board and at least a portion of the radio frequency antenna.

8. The electronic device of claim 7, wherein the environmentally hardened enclosure further houses the power supply.

9. The electronic device of claim 1, further comprising a screw-type socket wired in parallel with the screw-type plug.

10. The electronic device of claim 9, wherein the powered circuit board can detect a screw-type light bulb that has been placed into the screw-type socket and relay an operational status of the screw-type light bulb over the wireless radio frequency access network.

11. The electronic device of claim 1, further comprising a Joint Test Action Group (JTAG) interface that can perform a boundary scan to access information relating to one or more components of the electronic device.

12. The electronic device of claim 11, wherein the JTAG interface comprises an IEEE 1149.1 interface that includes an access port for testing the device for one or more of a short circuit, an open circuit, or a logic error.

13. An externally powered electronic device that provides connectivity to a wireless radio frequency access network, comprising:
a screw-type plug that can be screwed into a standard alternating current light socket, wherein the screw-type plug has at least one electrical contact that draws an alternating current voltage from the light socket;
a power supply electrically coupled to the screw-type plug, wherein the power supply converts the alternating current voltage drawn from the light socket into a direct current voltage that powers a circuit board;
a local area radio frequency antenna, wherein the powered circuit board causes the local area radio frequency antenna to transmit and receive information using a first predetermined frequency and a first predetermined network protocol, thereby providing connectivity to a wireless local area network; and
a wide area radio frequency antenna, wherein the powered circuit board causes the wide area radio frequency antenna to transmit and receive information using a second predetermined frequency and a second predetermined network protocol, thereby linking the wireless local area network to a wireless wide area network.

14. The electronic device of claim 13, wherein the first predetermined network protocol comprises an IEEE 802.11 network protocol and the second predetermined network protocol comprises an IEEE 802.16 network protocol.

15. The electronic device of claim 13, wherein each of the first predetermined network protocol and the second predetermined network protocol include at least one of an IEEE 802.11 protocol, an IEEE 802.16 network protocol, or a 3GPP Long Term Evolution network protocol.

16. A method for providing external power to an electronic device that provides connectivity to a wireless radio frequency access network, comprising:
screwing the electronic device into a standard alternating current light socket via a screw-type plug coupled to the electronic device, the electronic device operable when screwed into the light socket to:
draw an alternating current voltage from the light socket via at least one electrical contact in the screw-type plug;
convert the alternating current voltage drawn from the light socket into a direct current voltage; and
provide power to a circuit board, the powered circuit board operable to cause a local area radio frequency antenna to transmit and receive information using a predetermined frequency and a predetermined network protocol that provide connectivity to a wireless local area network.

17. The method of claim 16, the powered circuit board further operable to cause a wide area radio frequency antenna to transmit and receive information using a second predetermined frequency and a second predetermined network protocol that link the wireless local area network to a wireless wide area network.

18. The electronic device of claim 17, wherein each of the first predetermined network protocol and the second predetermined network protocol include at least one of an IEEE 802.11 protocol, an IEEE 802.16 network protocol, or a 3GPP Long Term Evolution network protocol.

19. A system for providing external power to a plurality of electronic devices that provide connectivity to a wireless radio frequency access network, comprising:
a wireless wide area network that operates using a first predetermined frequency and a first predetermined network protocol; and
a plurality of wireless access points, each of which include:
a screw-type plug that can be screwed into a standard alternating current light socket, wherein the screw-type plug has at least one electrical contact that draws an alternating current voltage from the light socket;
a power supply electrically coupled to the screw-type plug, wherein the power supply converts the alternating current voltage drawn from the light socket into a direct current voltage that powers a circuit board;
a local area radio frequency antenna, wherein the powered circuit board causes the local area radio frequency antenna to transmit and receive information using a second predetermined frequency and a second predetermined network protocol, thereby providing connectivity to a wireless local area network; and
a wide area radio frequency antenna, wherein the powered circuit board causes the wide area radio frequency antenna to transmit and receive information using the first predetermined frequency and the first predetermined network protocol, thereby linking the wireless local area network to the wireless wide area network.
